(19) United States
(12) Patent Application Publication
(10) Pub. No.: US 2012/0297995 A1
(43) Pub. Date: Nov. 29, 2012

(54) DEVICE FOR CONVEYING A SHEET THROUGH A PRINTING PRESS

(75) Inventor: HENNING NIGGEMANN, DOSSENHEIM (DE)

(73) Assignee: HEIDELBERGER DRUCKMASCHINEN AG, HEIDELBERG (DE)

(21) Appl. No.: 13/473,769

(22) Filed: May 17, 2012

(30) Foreign Application Priority Data
May 24, 2011 (DE) 10 2011 102 444.5

(51) Int. Cl. B41F 21/04

(52) U.S. Cl. 101/232

(57) ABSTRACT

A gripper control gearing has a reduced complexity for providing adjustments. Stops are provided on a reversing drum for a slide that supports cam rollers. Pinions with a helical toothing are arranged on a gripper shaft and on a gripper tube. Such a simplified arrangement allows for easier adjustments of the gripper system.

### CROSS-REFERENCE TO RELATED APPLICATION

This application claims the priority, under 35 U.S.C. §119, of German application DE 10 2011 102 444.5, filed May 24, 2011; the prior application is herewith incorporated by reference in its entirety.

### BACKGROUND OF THE INVENTION

### Field of the Invention

The invention relates to a device for conveying a sheet through a printing press.

Published, non-prosecuted German patent application DE 10 2005 045 287 A1, corresponding to U.S. Pat. No. 7,412,925, discloses a perfecting press in which a reversing device including a reversing drum and a storage drum is provided between two printing units. The reversing drum includes pincer-type grippers with gripper fingers disposed on a gripper shaft and on a coaxial gripper tube. The gripper fingers are pivotable independently of each other about the axis of the gripper shaft and of the coaxial gripper tube, respectively, in order to open and close to take over a sheet from the storage drum and to transfer the sheet to a downstream impression cylinder. To initiate the opening or closing of the gripper fingers and the pivoting of the gripper fingers, a respective pinion is provided on the end of the gripper shaft and of the gripper tube. A toothed segment engages in the pinion. The respective toothed segment is pivotably mounted to a slide. A cam roller supported on a track of a control cam that is fixed to a frame is provided on each toothed segment. Separate control cams are provided for the straight-printing mode and for the perfecting mode. To switch between modes of operation, the slide is displaced in the axial direction of the reversing drum to cause the respective cam roller to be supported on the track of a desired control cam. When the slide is displaced, the toothed segments remain in engagement with the pinions, which have a straight toothing. The displacement of the slide is predetermined by the geometry of an eccentric that is used to make the adjustment by hand.

To ensure that the gripper fingers assume a desired pivoting position for receiving or transferring a sheet, the control cams and the stops of the gripper fingers are adjustable. A rotation of a control cam about the axis of rotation of the reversing drum causes a phase shift of the angular position of the reversing drum for opening or closing the gripper fingers. Stop screws of the gripper fingers are adjusted to adapt the gripper opening width so that the angular range in which the gripper fingers are closed is adjustable. In addition, the phasing of the gripper shaft or gripper tube can be adjusted based on the tooth distribution of the pinion in order to adjust the height of the gripper surface of the gripper fingers relative to the sheet during a takeover or transfer.

A disadvantage of the known designs of a reversing drum that has the adjustment options described above is that the angular positions and gripper heights are not adjustable independently of each other in the two modes of operation. Gripper height errors and angular position errors that are due to manufacturing tolerances of the components or due to a deformation of the components can be corrected in the straight printing mode; yet this causes the angular positions and gripper heights to change in the perfecting mode, too. It is possible to average the aforementioned errors in both modes of operation.

A disadvantage of correcting the gripper height by offsetting the position of the pinion on the gripper shaft or gripper tube is that it involves changing and readjusting the angular position of the gripper fingers.

Due to the fact that an adjustment of the gripper in one mode has an influence on the gripper adjustment in the other mode and that an adjustment of the angular position has an influence on the gripper height and vice versa, any adjustment is complex and time consuming.

### SUMMARY OF THE INVENTION

An object of the invention is to develop a device for conveying a sheet through a printing press that provides ways to reduce the complexity involved in an adjustment to a gripper control gearing of a reversing drum and to reduce deviations of the movement of gripper fingers from a desired movement.

With the foregoing and other objects in view there is provided, in accordance with the invention a device for conveying a sheet through a printing press. The device contains a transfer drum having a drum body, a gripper system disposed on the transfer drum and includes gripper fingers that cooperate in pairs, and a gear train for moving the gripper system. The gear train has at least one pinion with a helical toothing. A slide is displaceable on the drum body in a axial direction of the transfer drum into two stop positions. Elements for controlling a movement of the gripper fingers are provided. The elements are disposed on the slide to switch between a straight-printing mode and a perfecting mode. At least one stop is adjustable to determine the stop positions of the slide.

In accordance with the invention, adjustable stops for a slide displaceable in the axial direction of a reversing drum are provided on the reversing drum. The slide supports at least one roller lever including cam rollers interacting with control cams for moving grippers of a pincer-type gripper system. A toothed segment engaging in a pinion with a helical toothing is provided on the roller lever.

Other features which are considered as characteristic for the invention are set forth in the appended claims.

Although the invention is illustrated and described herein as embodied in a device for conveying a sheet through a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side view of a reversing device in a sheet-fed printing press, including a storage drum and a reversing drum illustrated in the straight printing mode according to the invention;

FIG. 2 is a detailed, side view of a pincer-type gripper system;

FIG. 3 is a side view of the reversing drum shown in FIG. 1 in a perfecting mode;

FIG. 4 is a front view of the reversing drum;

FIG. 5 is a side view of a sheet transfer between the storage drum and the reversing drum in the straight-printing mode;

FIG. 6 is a side view of a sheet transfer between the storage drum and the reversing drum in the perfecting mode;

FIG. 7 is a side view of a sheet transfer between the reversing drum and the impression cylinder in the straight-printing mode and in the perfecting mode;

FIG. 8 is a side view of a gripper height adjustment in the straight-printing mode;

FIG. 9 is a side view of a gripper height adjustment in the perfecting mode;

FIG. 10 is a front view of the reversing drum with a divided slide; and

FIG. 11 is a table indicating the various adjustment options.

### DETAILED DESCRIPTION OF THE INVENTION

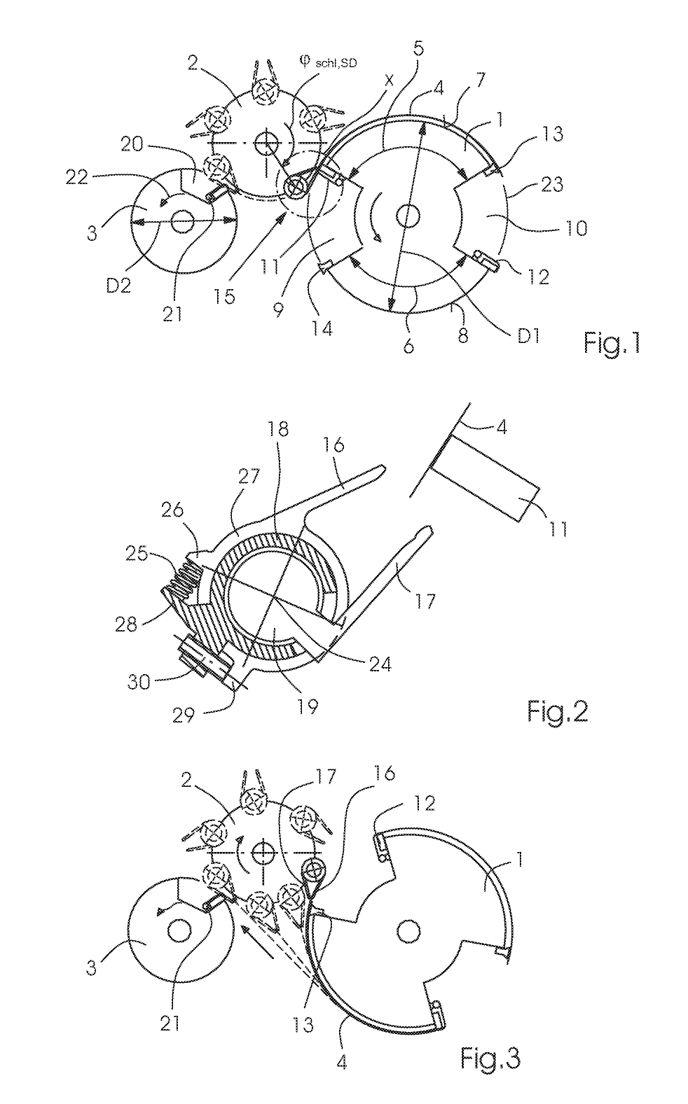

Referring now to the figures of the drawing in detail and first, particularly, to FIG. 1 thereof, there is shown a storage drum 1, a reversing drum 2, and an impression cylinder 3 in a sheet-fed printing press in a straight-printing mode. The storage drum 1 has two segments 5, 6 adjusted to accommodate the length of a sheet 4 and having lateral surfaces 7, 8 shaped like a cylinder shell, and two gaps 9, 10. Mechanical gripper systems 11, 12 for holding leading edges of sheets and suction gripper systems 13, 14 for holding trailing edges of sheets are located in the gaps 9, 10. The reversing drum 2 is provided with a pincer-type gripper system 15. As shown in FIG. 2, gripper fingers 16, 17 of the pincer-type gripper system 15 are fixed to a gripper tube 18 and to a coaxial gripper shaft 19, respectively. A further mechanical gripper system 21 for gripping the leading edge of a sheet 4 is provided in a gap 20 formed in the impression cylinder 3.

The storage drum 1, the reversing drum 2, and the impression cylinder 3 are supported in side walls of the printing press and are driven in the direction indicated by arrows 22 in synchronism with each other. While being conveyed by the storage drum 1, a sheet 4 rests on a revolving contour 23 that has an effective diameter D1, which is twice the effective diameter D2 during transport by the reversing drum 2 or the impression cylinder 3. In the rotational positions of the storage drum 1 and of the reversing drum 2 shown in FIG. 1, a sheet 4 is transferred from the grippers of gripper system 11 into the pincer grippers 16, 17 of the pincer-type gripper system 15. Subsequently, the pincer grippers 16, 17 carry out a pivoting movement about a common axis 24 of gripper tube 18 and gripper shaft 19. The dashed lines in FIG. 1 illustrate the pivoting and opening positions of the pincer grippers 16, 17 for various rotational positions of the reversing drum 2.

As shown in more detail in FIG. 2, the pincer grippers 16, 17 are open against the force of a spring 25 in order to receive the sheet 4. The spring is supported between a first protrusion 26 formed on a gripper housing 27 that supports a pincer gripper 16, and a second protrusion 28 formed on the gripper tube 18. The opening width of the pincer grippers 16, 17 is determined by a stop 29 on the gripper shaft 19 and an adjustable stop screw 30 provided on the gripper tube 18.

In FIG. 3, the storage drum 1, the reversing drum 2, and the impression cylinder 3 are shown in a perfecting mode. In the illustrated rotational position of the reversing drum 2, the pincer grippers 16, 17 take over a trailing edge of a sheet 4 from the suction elements of a suction gripper system 13. As the reversing drum 2 continues to rotate, the movement of the sheet 4 is reversed and the edge that was the trailing edge on the storage drum 1 becomes the leading edge. The reversed sheet 4 is transferred to the grippers of the gripper system 21 of the impression cylinder 3 to be printed.

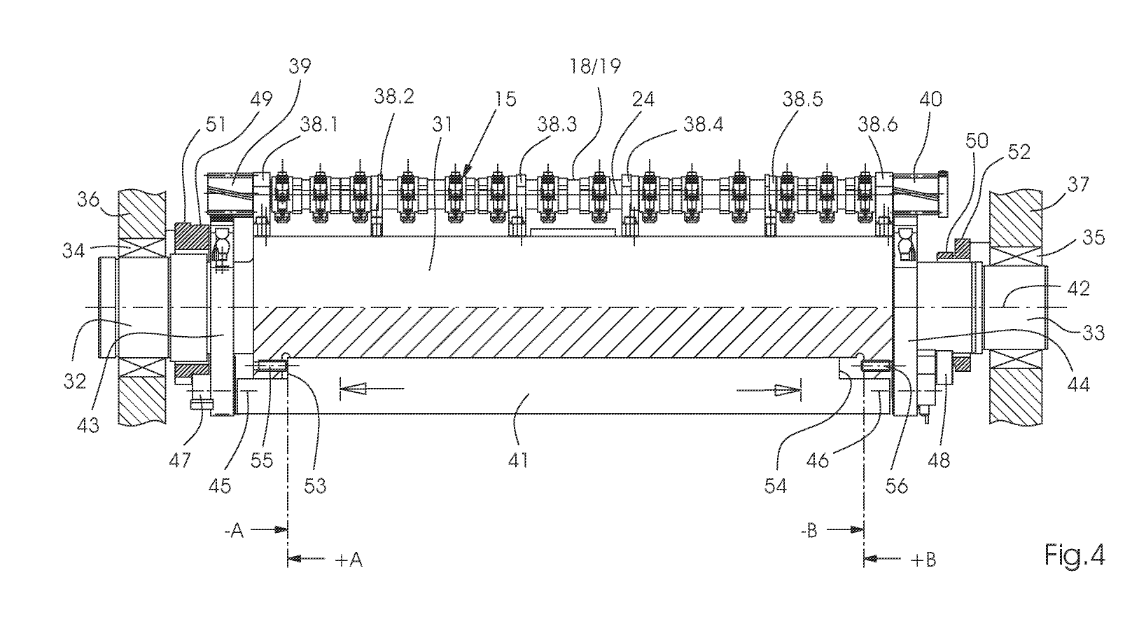

FIG. 4 is a front view of the reversing drum. The reversing drum consists of a drum body 31 with axial journals 32, 33 received in bearings 34, 35 provided in side walls 36, 37. Vertical bearings 38.1 to 38.6 are provided on the drum body 31 for supporting the gripper tube 18 and the gripper shaft 19 supported in the gripper tube 18, respectively. A respective pinion 39, 40 with helical toothing is located on a respective end of the gripper tube 18 and the gripper shaft 19. On the drum body 31 side facing away from the gripper tube 18 and the gripper shaft 19, a slide 41 displaceable in the direction of the axis of rotation 42 of the reversing drum 2 is provided. Toothed segments 43, 44 are pivotably supported on both sides of the slide 41. The pivot axes 45, 46 of the toothed segments 43, 44 are parallel to an axis of rotation 42. The teeth of the toothed segments 43, 44 engage in the pinions 39, 40. Cam rollers 47, 48 are arranged on the toothed segments 43, 44 so as to be supported on tracks formed on cams 49, 50 and 51, 52, respectively, which are fixed to a frame.

The slide 41 has two stop surfaces 53, 54, which interact with two adjustable stop screws 55, 56 provided on the drum body 31. Depending on whether the slide 41 is pushed against stop screw 55 or stop screw 56, the respective cam roller 47, 48 rests on the track of cams 49, 50 for the straight-printing mode or of cams 51, 52 for the perfecting mode.

An adjustment of the stop screws 55, 56 limits the displacement path of the slide 41 in the direction of axis 42. When the slide 41 is moved, the teeth of the toothed segments 43, 44 are continuously in engagement with the pinions 39, 40. Due to the helical toothing of the pinions 39, 40, the gripper tube 18 and the gripper shaft 19 pivot as the slide 41 is displaced. The pivoting of the gripper tube 18 and of the gripper shaft 19 upon a changeover between modes is compensated by an appropriate design of the cams 49 and 52 to ensure that the desired gripper movement is implemented both in the straight-printing mode and in the perfecting mode. Using the stop screws 55, 56, it is possible to adjust the gripper heights h independently for both modes of operation by adjusting the end positions of the slide 41.

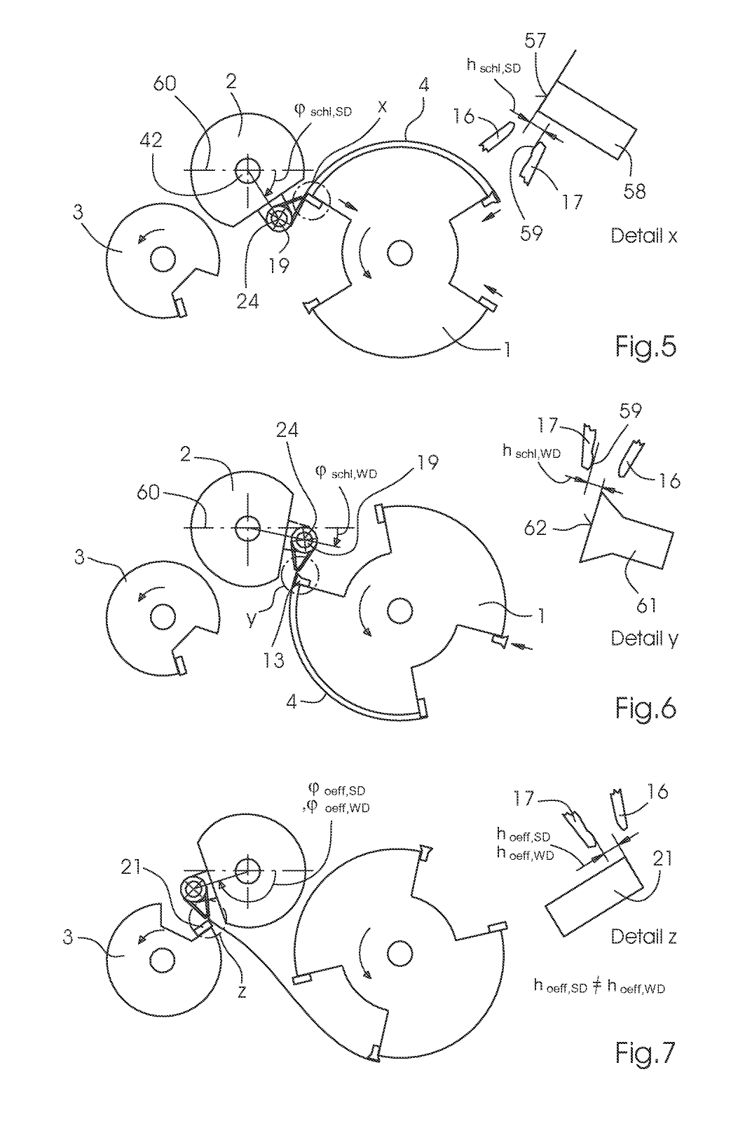

Stop screw 55 limits the end position of the slide 41 in the straight-printing mode. As shown in more detail in FIG. 5, the stop screw 55 can be used to adjust gripper height h_{schl,SD}, which is required for a defined rotational position Ø_{schl,SD}, to take a sheet 4 from the grippers of the gripper system 11, 12 of the storage drum 1. This gripper height h_{schl}, so is determined by the spacing between the sheet support surfaces 57 of gripper pads 58 of a the gripper system 11, 12 and the gripping surfaces 59 of gripper fingers 17. The angle Ø_{schl}, so for the rotational position of the reversing drum 2 is given as the angle through which the gripper shaft 19 is rotated about axis 42 relative to a horizontal plane 60.

The stop screw 56 limits the end position of the slide 41 in the perfecting mode. As shown in FIG. 6, the stop screw 56 is used to adjust the gripper height h_{schl,WD} at the moment of transfer of a sheet 4 from suction elements 61 of a suction gripper system 13, 14. At the moment of transfer of the sheet 4, the reversing drum 2 is in a rotational position Ø_{schl,WD}. The gripper height h_{schl, WD} is determined by the spacing between the suction surfaces 62 of the suction elements 61 and the gripping surface 59 of the gripper fingers 17.

As shown in FIG. 7, both in the straight-printing mode and in the perfecting mode, at the moment of transfer of a sheet 4 to the grippers of the gripper system 21 of the impression cylinder 3 the reversing drum 2 reaches a rotational position Ø_{oeff,SD=Øoeff,WD}. In this rotational position, the gripper height in the straight-printing mode is h_{oeff,SD} and the gripper height in the perfecting mode is h_{oeff, WD}, with h_{oeff,SD} h_{oeff, WD}.

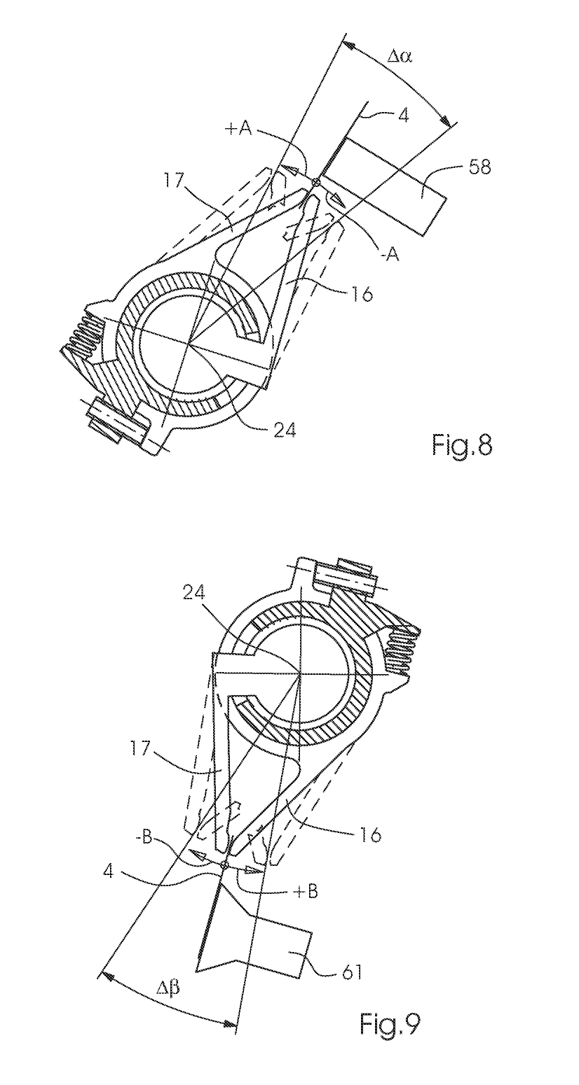

FIGS. 8 and 9 illustrate adjustments of the gripper height in the straight printing mode and in the perfecting mode by the stop screws 55 and 56. When the3 stop screw 55 is adjusted in a direction −A or +A for a straight-printing operation, the gripper fingers 16, 17 rotate about axis 24 through an angular range Δα due to the helical toothing of the pinions 39, 40. As long as there is no adjustment of the stop screw 56, the gripper movement in the perfecting mode remains unaffected.

As shown in FIG. 9, by an adjustment of the stop screw 56, the gripper fingers 16, 17 can be adjusted in terms of their height over an angular range Δβ for a perfecting operation without affecting the adjustment for the straight-printing mode.

In any case, an adjustment of the stop screws 55, 56 to correct gripper height errors does not have any influence on the opening and closing angle of the gripper fingers 16, 17.

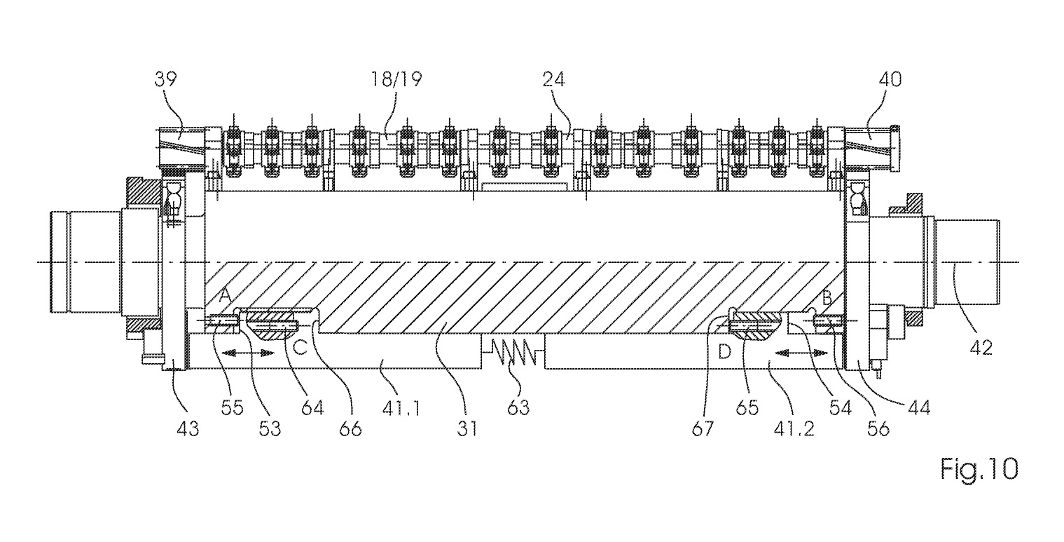

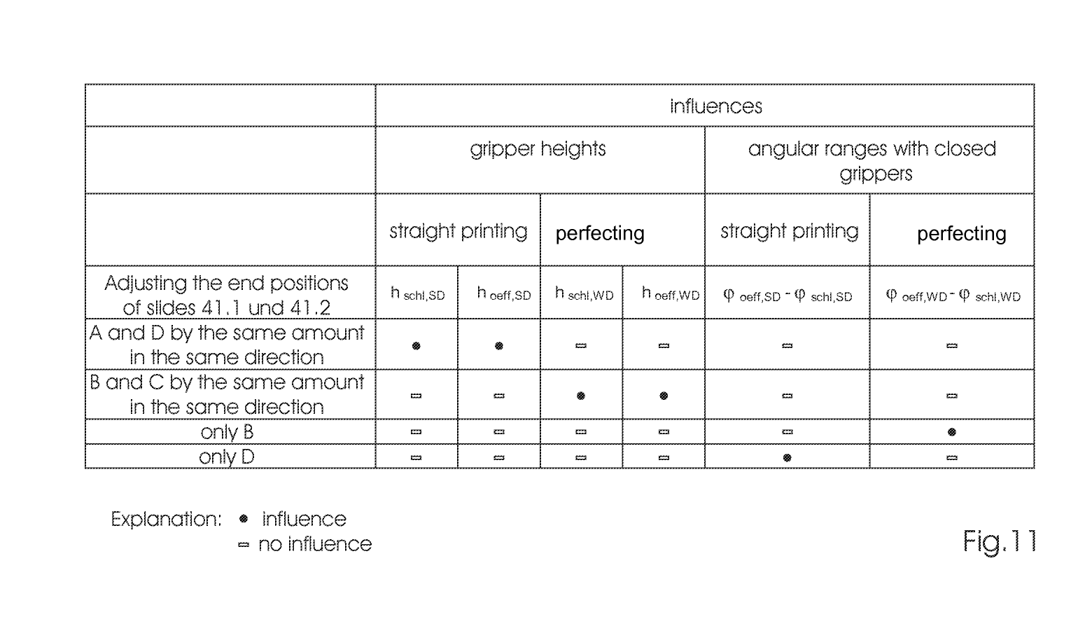

FIG. 10 illustrates an exemplary embodiment including a divided slide 41.1, 41.2 of the reversing drum 2 configured as shown in FIG. 4. The illustrated embodiment provides improved ways of adjusting the closing and opening angles of the gripper fingers 16, 17 in addition to an adjustment of the gripper height independently of the mode of operation. As described with reference to FIG. 4, the pinions 39, 40 have a helical toothing. Thus during a changeover between modes, an axial displacement of the slide parts 41.1, 41.2 with the toothed segments 43, 44 supported thereon causes the gripper shaft 19 and the gripper tube 18 to rotate. The toothed segment 43 that is supported on slide part 41.1 is used to drive the gripper shaft 19. The toothed segment 44 that is supported on slide part 41.2 drives the gripper tube 18. The slide parts 41.1, 41.2 are coupled by a spring element 63. The end positions of slide 41.1 are defined by adjustable stop screws 55, 64. Adjustable end screws 56, 65 limit the displacement path of the slide part 41.2 in the axial direction 42. Different settings of the stop screws 55, 64 and 56, 65, respectively, result in different displacement paths of the slide parts 41.1, 41.2. These different displacement paths are compensated by the spring element 63. If the slide part 41.1 is connected to an actuating drive for axial displacement, the adjustment paths and stop positions are designed in such a way that slide part 41.2 always contacts stop screw 65 when the slide part 41.1 is in the straight-printing position against stop screw 55. If slide part 41.1 is in the perfecting position against stop screw 64, slide part 41.2 is in contact with stop screw 56. Stop screws 64, 65 interact with stop surfaces 66, 67 provided on the drum body 31.

As indicated by the table of FIG. 11, the gripper heights h of the gripper fingers 16, 17 and the angular ranges Ø_{oeff-Ø}_{schl} with closed gripper fingers 16, 17 can be adjusted by adjusting the stop screws 55, 56, 64, 65. As becomes apparent from the table, the stop screws 55, 65 need to be adjusted by the same amount and in the same axial direction to adjust the gripper heights in the straight-printing mode. To adjust the gripper heights in the perfecting mode, it is necessary to adjust the stop screws 56, 64 by the same amount and in the same axial direction. If only the stop screw 56 is adjusted, the angular range with the closed gripper fingers 16, 17 can be adjusted in the perfecting mode. If only the stop screw 65 is adjusted, the adjustment only has an effect on the angular range with closed gripper fingers 16, 17 in the straight-printing mode. The stop positions of the slide parts 41.1, 41.2, which are indicated by letters A to D in FIGS. 10 and 11, are defined by stop screws 55, 56, 64, 65.

Due to the helical toothing of the pinions 39, 40, an adjustment of the stop screw 55 results in an adjustment of the gripper shaft 19 about axis 24 in the straight printing mode without any influence on the rotational position of the gripper tube 18 about axis 24. An adjustment of stop C causes an adjustment of the gripper shaft 19 in the perfecting mode without any influence on the gripper tube 18. When the stop screw 65 is adjusted, the gripper tube 18 is adjusted in the straight-printing mode without any influence on gripper shaft 19. When the stop position B with the stop screw 56 is modified, the rotational position of the gripper tube 18 about axis 24 is adjusted in the perfecting mode without any influence on the gripper shaft 19.

1. A device for conveying a sheet through a printing press, the device comprising:
a transfer drum having a drum body;
a gripper system disposed on said transfer drum and including gripper fingers that cooperate in pairs;
a gear train for moving said gripper system, said gear train having at least one pinion with a helical toothing;
a slide being displaceable on said drum body in a axial direction of said transfer drum into two stop positions;
elements for controlling a movement of said gripper fingers, said elements being disposed on said slide to switch between a straight-printing mode and a perfecting mode; and
at least one stop being adjustable to determine the stop positions of said slide.

2. The device according to claim 1, wherein:
said at least one stop is one of two respective adjustable stops; and
said slide includes a spring element and two slide parts, which are coupled by said spring element, and displacements of said two slide parts are limited by said two respective adjustable stops.
